(19) United States
(12) Patent Application Publication
(10) Pub. No.: US 2010/0046477 A1
(43) Pub. Date: Feb. 25, 2010

(54) Method for Hand-Over In A Heterogeneous Wireless Network

(75) Inventors: James S. Marin, Murphy, TX (US); George Cherian, San Diego, CA (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/194,120

(22) Filed: Aug. 19, 2008

(51) Int. Cl. H04W 36/30

(52) U.S. Cl. 370/332

(57) ABSTRACT

In a heterogeneous network handover situation, a mobile terminal (110) is initially in wireless communication with a source network (130). The mobile terminal transmits, to a target network (170), a target network overhead update request message (315, 325) containing location information of the mobile terminal and receives, from the target network, a target network overhead update response message (317, 327) containing overhead message information for the target network and optionally other information such as handover willingness, network loading, and QoS availability. The update request and update response messages can be tunneled from the mobile terminal through the source network and the core network to the target network, rather than the messages being sent over-the-air from the target network to the mobile terminal.

### CROSS REFERENCE TO RELATED APPLICATIONS

This application is related to the following co-pending U.S. patent application Ser. No. 11/778,746 (Docket No. CS33310), “Method of Establishing an HRPD Link” by George Cherian and Poornima Lalwaney filed on Jul. 17, 2007. This related application is assigned to the assignee of the present application and is hereby incorporated herein in its entirety by this reference thereto.

### FIELD OF THE DISCLOSURE

This disclosure relates generally to hand-over of a mobile terminal and in particular to hand-overs within heterogeneous wireless networks.

### BACKGROUND OF THE DISCLOSURE

Within a homogeneous wireless network, a source base station traditionally controls hand-over of mobile terminals under its control. This is commonly referred to as Base-Controlled Hand-Over/Hand-Off (BCHO). In the industry, a “source base station” is sometimes called a “serving base station” (i.e., the base station that is serving the mobile terminal before a handoff), and a “target base station” is the base station that will become the serving base station after a handoff. The source base station usually has target base station information (such as the target base station's location, pseudorandom noise (PN) codes, control channel frequencies, and resource information) and network operator management considerations (such as load balancing algorithms and preferred network information). The target base station information known by the source base station can be augmented by actual signal level and/or signal quality measurements fed back from the mobile terminal in neighbor list measurement reports and the like. A hand-over using this additional mobile terminal feedback is generally described as a Mobile-Assisted Hand-Over/Hand-Off (MAHO). An MAHO, however, is still ultimately controlled by a base station. Within homogeneous networks, handoff (whether BCHO or MAHO) is often tightly-coupled, which involves the passing of link layer (i.e., Layer 2) radio-specific parameters between the source and target base stations. As a result, a hand-over between tightly-coupled networks generally results in a short user data delay (e.g., 100 microseconds) and/or few missing packets, which is generally acceptable to most users in both real-time data (e.g., Voice of IP) and non-real-time data (e.g., wireless internet and instant messaging) applications.

Within a heterogeneous wireless network, however, link layer information from a target base station is not readily available at a source base station (which is using a different access network protocol). Thus, heterogeneous network handoffs (both BCHO and MAHO) are loosely-coupled, which means they use network layer (i.e., Layer 3) messages to re-route traffic from a source base station to a target base station. This creates a longer hand-over process which may produce a user data delay ranging from several seconds to several minutes and/or many missing packets. These longer delays and/or packet errors become more and more perceptible to a user and eventually become unacceptable—especially in real-time data applications.

### BRIEF DESCRIPTION OF THE DRAWINGS

Embodiments of the inventive aspects of this disclosure will be best understood with reference to the following detailed description, when read in conjunction with the accompanying drawings.

FIG. 1 illustrates an example of a heterogeneous WiMAX to High Rate Packet Data (HRPD) network architecture in accordance with an embodiment.

FIG. 2 shows a generic heterogeneous network architecture in accordance with an embodiment.

FIGS. 3A, 3B, and 3C is an example signal flow diagram for WiMAX to HRPD active hand-off in accordance with an embodiment.

FIG. 4 shows a Protocol Stack in accordance with an embodiment.

FIG. 5 is an example of a Target Overhead Update Request message in accordance with an embodiment.

FIG. 6 is an example of a Target Overhead Update Response message in accordance with an embodiment.

### DETAILED DESCRIPTION

Instead of using over-the-air messaging to gather overhead message information from target base stations, which may take a considerable amount of time and energy especially when using a single receiver mobile terminal, the mobile terminal requests and receives target base station overhead message information through a data tunnel through the source network between the mobile terminal and the target network (instead of over-the-air between the mobile terminal and the target network).

In addition to standard overhead message information such as quick configuration and sector parameter information, the Layer 3 communication can include information such as whether the target base station will accept a potential hand-over by the mobile terminal, the current loading of the target base station, and Quality of Service information from the target base station.

Using the target network information now available at the mobile terminal, the mobile terminal can conduct a mobile-controlled hand-over (MCHO) or provide this target network information to the source base station so that the source network can conduct a mobile-assisted hand-over (MAHO).

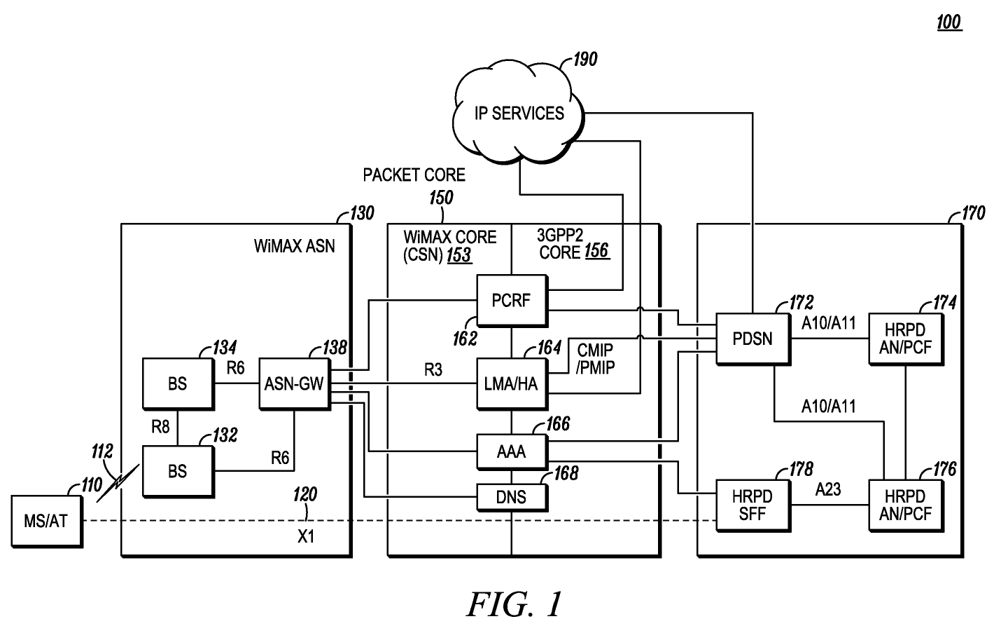

FIG. 1 illustrates an example of a heterogeneous WiMAX to non-WiMAX High Rate Packet Data (HRPD) network architecture 100. As used herein, the HRPD acronym generically refers to wireless wide area networks that can operate at data rates exceeding 1 Mbps and includes, by way of example, WCDMA UMTS, CDMA 1x EVDO and EVDV, HSDPA, and WiMAX.

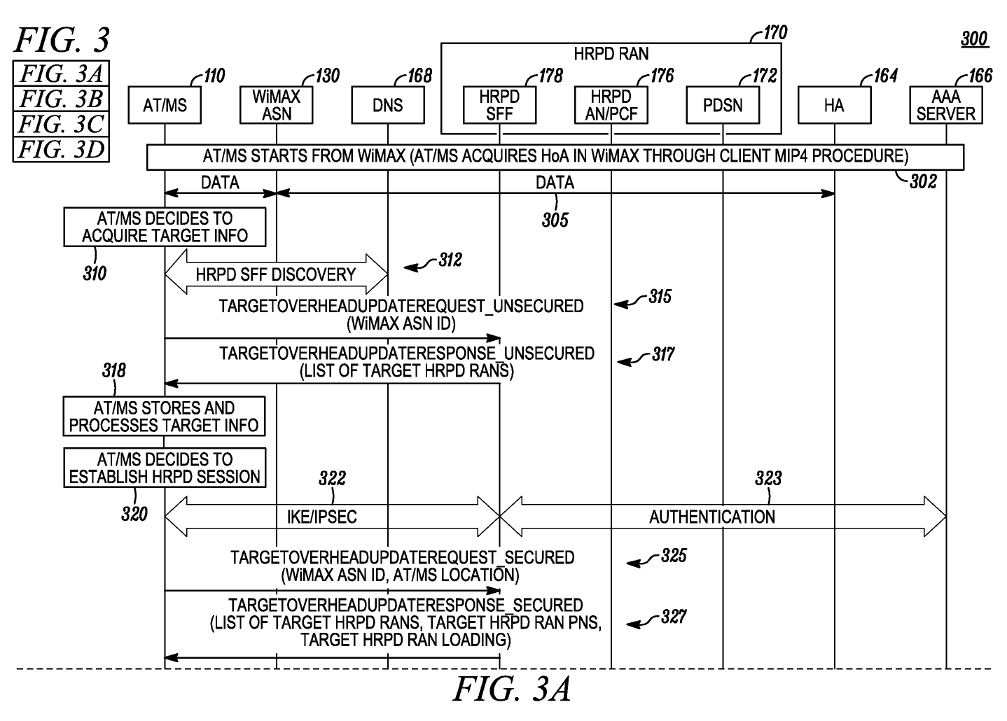

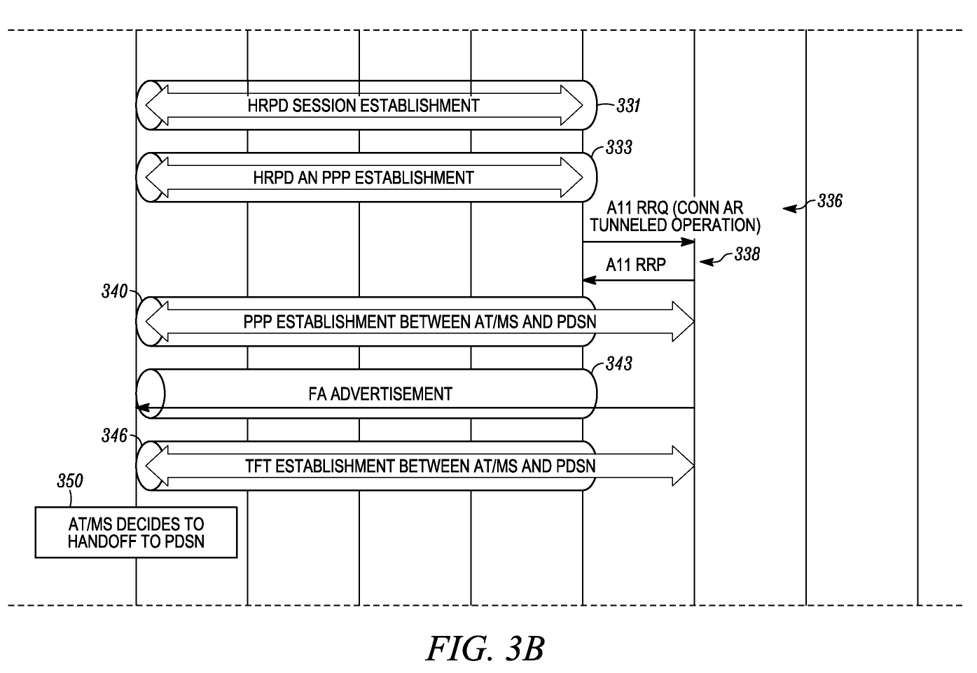

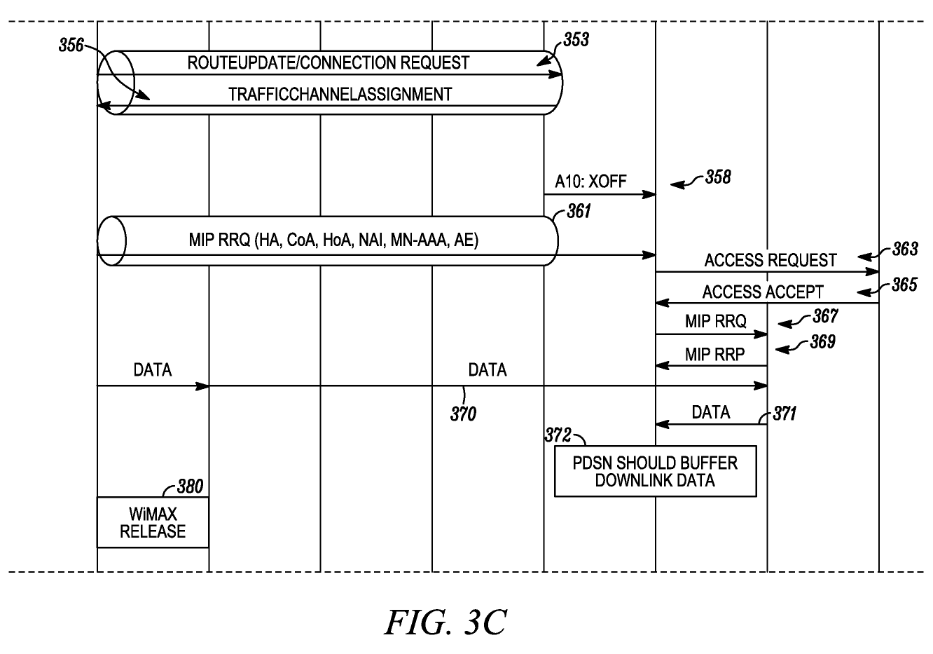

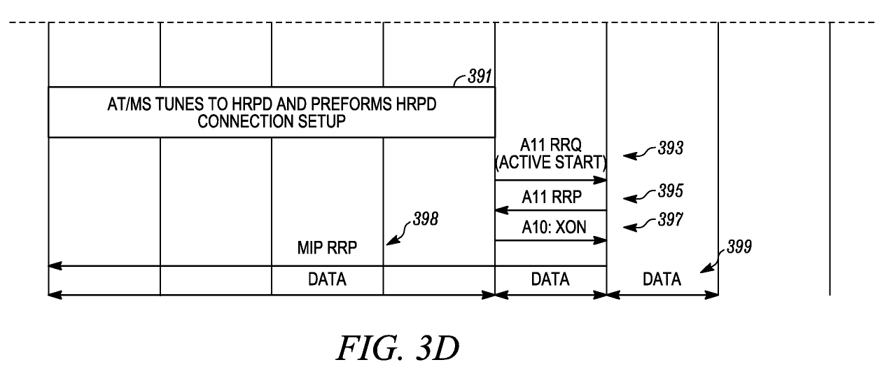

A dual-mode WiMAX-HRPD mobile terminal 110 is shown wirelessly connected 112 to a WiMAX access service network (ASN) 130, which is the source network in this illustration. A mobile terminal 110 is sometimes referred to as an access terminal, subscriber station, mobile station, or user equipment. The dual-mode mobile terminal 110 may have dual receivers or a single receiver. A benefit of a second receiver is that pre-establishing an HRPD session in preparation for handoff (which will be described in FIG. 3) may occur more quickly with a second receiver in the mobile terminal 110.

The WiMAX ASN 130 is connected to a core network 150. The core network 150 is also connected to an HRPD radio access network 170, which is a target network in this illustration. There may be more than one target network, but for purposes of simplicity this example only shows a single target network for hand-over.

The WiMAX ASN 130 is a typical access service network in accordance with IEEE 802.16 and WiMAX specifications. The WiMAX ASN 130 includes one or more base stations 132, 134 (sometimes called “access points”) communicating with each other via one or more R8 reference points. The base stations 132, 134 each communicate with a WiMAX ASN Gateway (GW) 138 via R6 reference points, and the WiMAX ASN GW 138 communicates with the core network 150.

The part of the core network 150 that communicates with the WiMAX ASN GW 138 is the WiMAX connectivity services network (CSN) 153. Another part of the core network 150, the 3GPP2 core 156, communicates with the HRPD RAN 170. Shared elements of the core network 150 include a Policy and Charging Rules Function (PCRF) 162, a Local Mobility Anchor/Home Agent (LMA/HA) 164, an Authentication, Authorization, and Accounting (AAA) server 166, and a Domain Name Server (DNS) 168. These shared elements support both WiMAX and HRPD networks. A Client Mobile Internet Protocol (CMIP)/Proxy Mobile Internet Protocol (PMIP) or “X3” interface can be used to regulate mobility management in different access networks. The PCRF 162, LMA/HA 164, and DNS 168 can be connected to IP services 190 such as an internet server, an intranet server, an IP Multimedia Subsystem (IMS), etc.

The HRPD RAN 170 includes a Packet Data Service Node (PDSN) 172 that communicates with the shared elements in the core network 150. The PDSN communicates via A10/A11 interfaces with one or more HRPD Access Network/Packet Control Function (AN/PCF) base stations 174, 176. An HRPD Signal Forwarding Function (SFF) 178 communicates with the AAA server 166 and also provides an internet protocol (IP) data tunnel 120 via an X1 interface between the HRPD RAN 170 and the mobile terminal 110 through the WiMAX core 153 and source network WiMAX ASN 130.

Although FIG. 1 has been shown anticipating a WiMAX to HRPD hand-over, it can be reversed to illustrate HRPD to WiMAX handovers or generalized to LTE to HRPD handovers, LTE to WiMAX handovers, and various other handovers within a heterogeneous network.

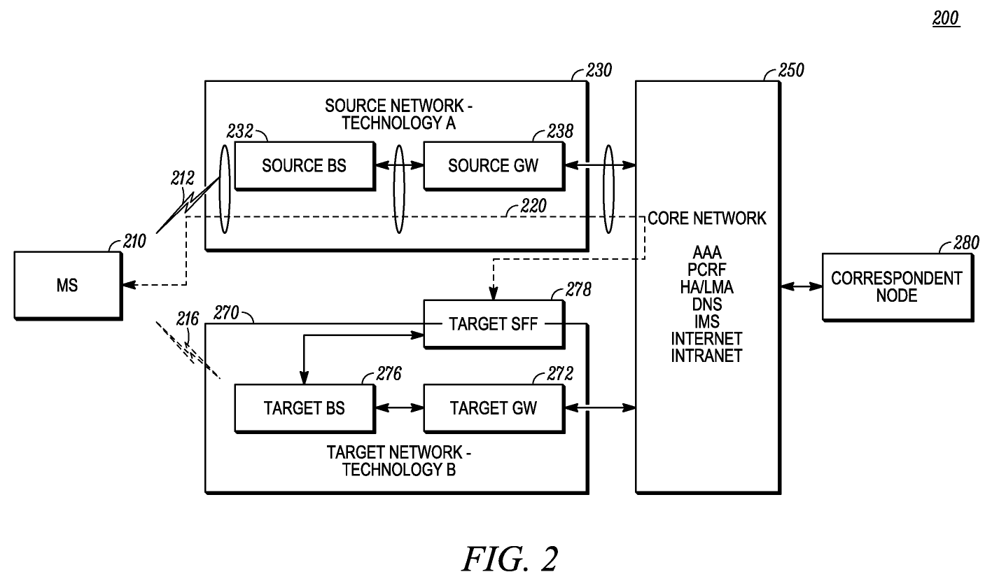

FIG. 2 shows a generic heterogeneous network architecture 200. A dual-mode mobile terminal 210 (sometimes referred to as a mobile station, subscriber station, access terminal, or user equipment) is currently in a dormant or active session using a first access mode technology (e.g., technology A) to communicate wirelessly with a source network 230. Through the source network 230 and a core network 250, the mobile terminal 210 can communicate with a correspondent node 280. The correspondent node 280 can be, for example, a land line telephone, an internet server, an intranet server, an instant messaging server, or another mobile terminal.

As stated previously, the mobile terminal 210 may have a single receiver or dual (or more) receivers. A source base station 232 handles the wireless communications between the mobile terminal 210 and the source network 230. A source gateway 238 communicates between the source base station 232 and the core network 250. The core network 250 supports both the source network 230 and the target network 270 which operates using a second access mode technology (e.g., technology B). Within the core network 250 are various elements previously discussed with reference to FIG. 1, such as an authentication, authorization, and accounting (AAA) server, gateways to other networks, mobility management servers, and a domain name server.

The target network 270 includes a target network SFF 278 that, together with the mobile terminal 210, establishes an IP data tunnel 220 through the core network and the source network. This data tunnel 220 provides a pathway to send target network overhead information to the mobile terminal 210 via the source network air interface 212 without requiring the mobile terminal 210 to receive this information via target system over-the-air messaging 216. The source network 230 treats messages in the tunnel 220 as common traffic and may be unaware that the tunnel contains handoff-related signaling. Thus, the source network 230 does not need to decode, reformat, or otherwise alter messages in the tunnel 220. The target network 270 also includes a target gateway 272 to interface between the core network 250 and the target network 270 as well as a target base station 276 to interface wirelessly between the target network 270 and the mobile terminal 210 during and after handover.

While the mobile terminal 210 is connected to the source network 230 via an air interface 212, in order to make a well-informed handover decision and reduce the time required for hand-over to complete, the mobile terminal 210 requests overhead information from the target network 270 via the data tunnel 220. Target base stations can then respond with overhead information that would otherwise be received over the target network 270 air interface 216. In addition to standard overhead information, a target base station can respond with whether it will or will not accept a handoff from the mobile terminal, loading information, Quality of Service information, and other information useful for deciding whether or not to handover to that target base station. With this overhead information, and especially when augmented with willingness, loading, and QoS information, the mobile station has additional data on which to base a handover decision.

FIG. 3 is an example signal flow diagram 300 for WiMAX to HRPD active hand-off in accordance with an embodiment. The network elements involved in the signal flow diagram 300 are a mobile terminal 110 (e.g., the dual-mode WiMAX HRPD mobile terminal 110 of FIG. 1 or the generic dual-mode mobile terminal 210 of FIG. 2), a source network 130 (e.g., the WiMAX ASN 130 of FIG. 1 or the source network 230 of FIG. 2), a DNS 168 (e.g., DNS 168 of FIG. 1 or a DNS element in a generic core network 250), a target SFF 178 (e.g., the PSDN SFF 178 of FIG. 1 or the target SFF 278 of FIG. 2), a target AN/PCF 176 (e.g., the HRPD AN/PCF 176 of FIG. 1 or the target base station 276 of FIG. 2), a PDSN 172 (e.g., the PDSN 172 of FIG. 1 or a generic target gateway 272), a Home Agent 164 (e.g., the LMA/HA 164 of FIG. 1 or a Home Agent element in a generic core network 250) and an authentication server 166 (e.g., the AAA server 166 of FIG. 1 or an AAA server element in a generic core network 250). The HRPD SFF 178, the HRPD base station 176, and the HRPD gateway 172 are all considered part of the HRPD access network 170 (e.g., HRPD RAN 170 of FIG. 1 or target network 270 of FIG. 2).

Initially, the mobile terminal 110 has its IP address 302 on the WiMAX network. Thus, the WiMAX network is the source network in this example. Depending on the network configuration, the IP address 302 can be a Mobile IP home address or care-of address, a PMIP Simple IP address, or another type of IP address. The mobile terminal 110 is in a data session 305 and data is passing from the mobile terminal 110 via the WiMAX ASN 130 to the home agent 164 in the core network.

At step 310, the mobile terminal 110 decides to obtain HRPD Access Network 170 element information. Step 310 can be triggered by mobile terminal provisioning (e.g., signal strength measurements below a certain threshold, degradation of signal over a certain rate, or passage of a pre-set amount of time), user command, or another mechanism. At this time 312, the mobile terminal 110 seeks the internet protocol (IP) address of a target SFF 178 which is associated with the HRPD Access Network 170 (see FIG. 1). In this implementation, the IP address is obtained from a DNS 168 in the core network. Alternately, the IP address could be retrieved from the mobile terminal's memory. After the target SFF's IP address is known, the mobile terminal 110 can send a Layer 3 Target Overhead Update Request unsecured message 315 to the target SFF 178. The unsecured request message 315 contains the WiMAX ASN 130 identifier to identify the source base station. Alternately or additionally, the unsecured request message 315 could provide geographic location information of the mobile terminal 110. At this point, the data tunnel between the mobile terminal 110 and the target SFF 178 is unsecured, thus it would be prudent to limit the message 315 to non-sensitive information. If both the source base station identifier and the geographic location of the mobile are considered sensitive, then the unsecured request message 315 does not need to be created or sent.

Upon receiving the unsecured request message 315, the target SFF 178 identifies one or more target network base stations that are likely to have a geographic coverage area that includes the mobile terminal 110. At this point, the target SFF 178 returns a Target Overhead Update Response unsecured message 317 with a list of target HRPD RANs, which includes the target AN/PCF 176 shown. The unsecured response message 317 can safely include non-sensitive overhead message information that might also be available over-the-air from the target network. This non-sensitive information could include not only the list of target HRPD RANs and/or HRPD base stations but also Pseudorandom Noise (PN) codes for specific base stations in each target HRPD RAN. For CDMA-based target RANs, overhead information can include: Pseudorandom Noise (PN) codes, PN offset, CDMA channel number, CDMA band class, Station Identifier (SID), network identifier (NID), Protocol Revision (P REV), BCCH code channel, BCCH data rate, BCCH coding rate, PCH code channel, and PCH data rate. For GSM-based target RANs, overhead information can include: BCCH number, country code, network code, location area code, cell identity, adjacent cell list, BCCH location, and minimum received signal strength.

The target SFF 178 can be configured as a simple IP router or a more complicated gateway into the HRPD RAN 170. If the target SFF 178 is configured as a router, the target SFF 178 will forward the unsecured request message 315 to one or more target base stations and forward corresponding unsecured response messages 317 from the target base stations back to the mobile terminal 110. If the target SFF 178 is configured with memory, a processor, interface ports, and software, it is possible for the target SFF 178 to look up stored target network information and create an unsecured response message 317 itself.

The mobile terminal 110 stores and processes target system information 318. The target system information may have been received by various methods, including over-the-air signaling (e.g., through air interface 212 or 216 of FIG. 2) and/or tunneled messages 317 (e.g., through the data tunnel 220 of FIG. 2).

In an MCHO situation, the mobile terminal 110 can autonomously choose to establish a session with the target network in step 320. Assuming that authentication is desirable (or required), the mobile terminal 110 communicates 322, 323 with the AAA server 166 via the HRPD SFF 178 to authenticate the mobile terminal 110 to the HRPD radio access network 170 and set up a secure IP data tunnel between the mobile terminal 110 and the target SFF 178 via the source network 130.

After the secure IP data tunnel is set up, the mobile terminal 110 may send a Target Overhead Update Request secured message 325. Because the communication link is now secured, more sensitive information can be sent in the request message 325. If both the source base station ID and the geographic location of the mobile terminal 110 are considered sensitive, then that information can be sent in this message 325; and message 315 is not required. If only the geographic location of the mobile terminal 110 is considered sensitive, then the source base station ID can be sent in the unsecured request message 315; and the location can be sent in the secured request message 325. Alternately, if only the source base station ID is considered sensitive, then the mobile terminal location information can be sent in the unsecured request message 315; and the source base station ID can be sent in the secured request message 325. Finally, if neither the source base station ID and the geographic location of the mobile terminal 110 are considered sensitive, then any or all of that information can be sent in either request message 315, 325 or both request messages 315, 325.

The HRPD SFF 178 can respond to the secured request message 325 with not only the information of the unsecured response message 317 but also with sensitive information such as: whether or not a particular base station 176 or target network 170 is willing to accept a handover of the mobile terminal 110, the current loading of a particular target base station, and/or the Quality of Service currently available from a target base station. Additional information can also be included in the secured response message 327. Again, depending on how the target SFF 178 is configured, the target SFF 178 can either act as a simple router or it can act as a gateway when receiving secured request messages 325 and transmitting secured response messages 327.

Based on the unsecured and/or secured response messages 317, 327, the mobile terminal 110 has information that can be used to select, search, and lock to a target base station (through the target system air interface) for handover. Additionally, the signal flow diagram 300 shows how to postpone the buffering of data on the source network from step 310 to later step 372 so that the handover occurs quicker and/or with fewer lost packets.

Specific implementations may replace the target SFF 178 with another entity that performs the functions outlined above, such as a specific target base station or a virtual base station acting as a proxy for a target base station. Any such entity is still considered a target SFF 178 for the purposes of this patent application.

Steps 331, 333, 336, 338, 340, 343, and 346 pre-establish an HRPD session over a non-HRPD access technology using tunneled messages that would otherwise be transmitted over the air interface of the target technology. In order to prepare for a reduced latency handover, the mobile terminal 110 can establish a session with the target network before the handoff occurs. In step 331, the mobile terminal 110 and the target AN/PCF 176 establish an HRPD session through an IP data tunnel (see tunnel 120 of FIG. 1 and tunnel 220 of FIG. 2) through the WiMAX ASN 130. In step 333, the mobile terminal 110 and the target base station 176 establish a point-to-point protocol (PPP) session with the HRPD AN/PCF 176 through the IP data tunnel. Mobile terminal authentication may be performed as part of step 331 or step 333.

At this point, the HRPD AN/PCF 176 recognizes that no A10 connection associated with the mobile terminal 110 is available, and the target AN/PCF 176 selects a PDSN 172. The HRPD AN/PCF 176 sends an A11 Registration Request message 336 to the PDSN 172 with a “tunneled operation” indicator. The tunneled operation indicator may be a WiMAX-HRPD handoff indicator, for example. The A11 Registration Request message is validated by the PDSN 172, and the PDSN 172 accepts the connection by returning an A11 Registration Reply message 338 with an “accept” indication. The A10 connection binding information at the PDSN 172 is updated to point to the HRPD AN/PCF 176.

In step 340, the mobile terminal 110 performs a PPP connection establishment procedure with the PDSN 172 and indicates it is a Mobile IP (MIP) session. The PDSN 172 sends a Foreign Agent (FA) Advertisement 343 to the mobile terminal 110 including a Care-of Address (CoA) for the mobile terminal to use as its IP address. The mobile terminal 110 then in step 346 establishes a traffic flow template (TFT) with the PDSN 172, if needed.

At this point, the mobile terminal 110 has successfully pre-established HRPD and PPP sessions in preparation for the handoff. In a BCHO or MAHO situation, the mobile terminal 110 would wait to receive a handover “control” message from the source network before proceeding with the handoff. The example in FIG. 3, however, is an MCHO situation and at step 350 the mobile terminal 110 decides to hand off to the HRPD network.

Steps 353, 356, 358, 361, 363, 365, 367, and 369 form a sequence of events that can be called handoff execution. Thus, the mobile terminal 110 sends Route Update and Connection Request messages 353 to the HRPD AN/PCF 176 through the existing IP tunnel. The HRPD AN/PCF 176 sends a Traffic Channel Assignment message 356 to the mobile terminal 110. The HRPD RAN 170 performs flow control with the PDSN 172 through an A10 connection off (Xoff) message 358 to indicate that the PDSN 172 should temporarily buffer data that may arrive when HA 164 changes the path of the data session 305 from the WiMAX ASN 130 to the PDSN 172.

After the traffic channel assignment procedure is complete (i.e., after message 356 is received by the mobile terminal 110), the mobile terminal 110 may tunnel a MIP Registration Request (RRQ) message 361 to the HRPD PDSN 172 through the HRPD AN/PCF 176. The mobile terminal 110 does not need to wait for an MIP Registration Response (RRP) message 369 before releasing the WiMAX air interface in step 380 and tuning a transceiver in the mobile terminal 110 to the HRPD air interface.

Triggered by the MIP RRQ message 361, the PDSN 172 sends an Access Request message 363 to the AAA server 166. Upon successful authentication, the AAA server 166 sends an Access Accept message 365 to the PDSN 172. The PDSN 172 forwards the MIP RRQ message 367 to the mobile terminal's home agent 164 to update the binding record of the data session (formerly data session 305), which causes the HA 164 to redirect the data session 370 from the WiMAX ASN 130 to the HRPD AN 170. The home agent 164 updates its binding record for the mobile terminal 110 and confirms with the PDSN 172 by replying with an MIP Registration Reply (RRP) message 369. At this step 372, the PDSN 172 should buffer the data session 371 containing data for the mobile terminal 110. Data 370 from the mobile terminal 110, however, can continue to flow until the mobile terminal 110 releases the WiMAX air interface in step 380.

Some time after sending the original MIP RRQ message 361, the mobile terminal 110 autonomously releases the WiMAX air interface resource in step 380. After releasing the WiMAX resource, the mobile terminal 110 tunes to the HRPD using (some of) the information received from the unsecured and secured Target Overhead Update Response messages 317, 327, as well as information received in the Traffic Channel Assignment message 356, and completes the HRPD connection setup in step 391. The HRPD AN/PCF 176 sends an A11 Registration Request message 393 to the PDSN 172 with an “Active Start” indication. The A11 Registration Request message is validated, and the PDSN 172 accepts the connection by returning an A11 Registration Reply message 395 with an “accept” indication. The HRPD AN/PCF 176 sends an A10 connection on (Xon) message 397 to the PDSN 172. The PDSN 172 forwards 398 the MIP RRP message 369 to the mobile terminal 110. Then the PDSN 172 resumes the data session 399 including the transmission of any data that may have been buffered 372 earlier at the PDSN 172.

After this step, core network data starts being forwarded to the HRPD RAN 170, which buffers the packets for the mobile terminal 110. Thus, the only span of time where real-time data services (such as VoIP) are discernibly suspended during the handover are from step 391 to receipt of message 398, which is considerably less than the suspension time had steps 331 through 361 been performed over-the-air with the target network rather than through the source network. At the conclusion of the handover, data 399 is being sent between the mobile terminal 110 and the HA 164 through the PDSN 172 and the HRPD AN/PCF 176.

Although the example in FIG. 3 specifically shows a WiMAX to HRPD handover, this handover process can be applied to other technology handovers such as HRPD to WiMAX, WiFi to HRPD, and the like.

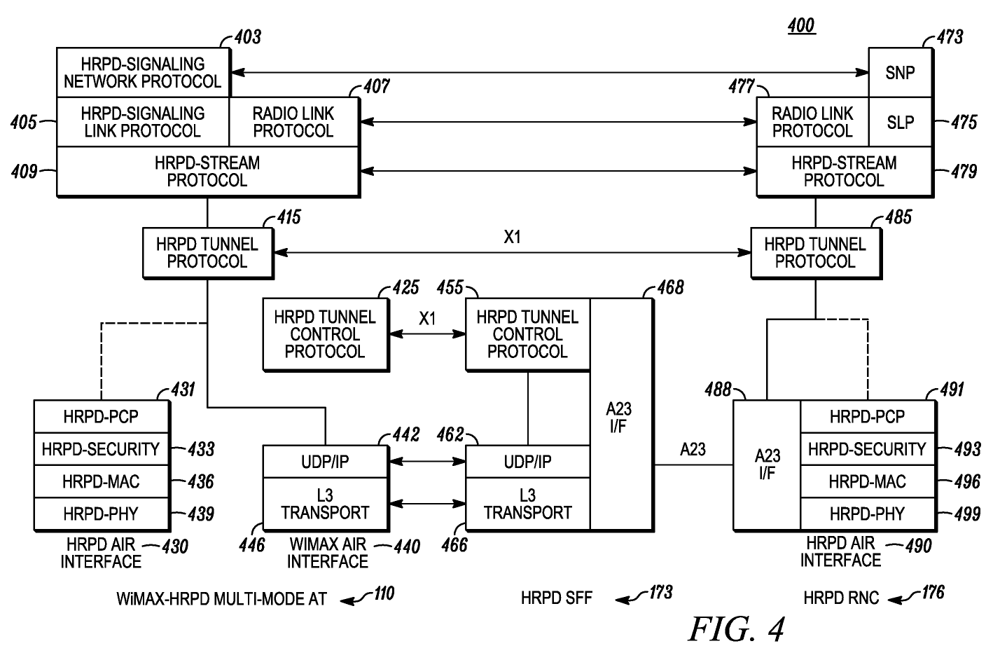

FIG. 4 shows a Protocol Stack 400 in accordance with an embodiment. A multi-mode mobile terminal 110 (which in this example is a WiMAX-HRPD terminal 110 but could be a generic multi-mode terminal 210) communicates with a target SFF 178 (which is shown as an HRPD SFF 178 but could be a generic target SFF 278) and a target RNC 176 (which is shown as HRPD AN/PCF 176 but could be a generic target base station 276).

At the network layers, an HRPD Signaling Network Protocol (SNP) 403 of the mobile terminal 110 communicates with a corresponding SNP 473 of the HRPD RNC 176, an HRPD Signaling Link Protocol (SLP) 405 communicates with a corresponding SLP 475 of the target RNC 176, a radio link protocol 407 of the mobile terminal 110 corresponds to a radio link protocol 477 of the target RNC 176, and a HRPD stream protocol 409 of the mobile terminal 110 has a corresponding HRPD stream protocol 479 at the HRPD RNC 176.

An HRPD tunnel protocol 415 of the mobile terminal 110 is used to communicate directly with the HRPD tunnel protocol 485 of the HRPD RNC 176. This protocol is useful when the HRPD SFF 178 is operating as a simple router. This protocol can carry, for example, the unsecured and secured Target Overhead Update request and response messages 315, 317, 325, 327 described in FIG. 3 as well as tunneled messages 331, 333, 336, 338, 340, 343, 346, 353, 356, 358, 361. Additionally, when the HRPD SFF 178 is operating with some memory and a processing unit as a gateway, an HRPD Tunnel Control Protocol 425 can be used to communicate with the HRPD SFF 178 HRPD Tunnel Control Protocol 455.

For data traffic over the WiMAX air interface 440 and through the WiMAX ASN 130 (not shown in FIG. 4), the mobile terminal 110 has a user datagram protocol/internet protocol (UDP/IP) 442 corresponding to the UDP/IP 462 at the HRPD SFF 178 and a Layer 3 (L3, e.g., IP layer) transport 446 in communication with the HRPD SFF 178 L3 transport 466. The HRPD SFF 178 has an A23 interface 468 corresponding to an A23 interface 488 at the HRPD RNC 176. The A23 interface 468, 488 is a communication path for X1 messages using the HRPD tunnel protocol 485. The A23 interface 468, 488 also uses header and routing information derived from information in the HRPD tunnel control protocol 425, 455. The A23 interface 488 on the HRPD RNC 176 is also an alternative communication path (i.e., a “back door”) for messages that would otherwise use the HRPD air interface 490 at the HRPD RNC 176. The HRPD air interface 490 includes layers 491, 493, 496, 499 that correspond with the mobile terminal 110 HRPD air interface 430 and layers 431, 433, 436, 439, respectively.

Thus, the HRPD SFF 178 can provide routing between the dual-mode mobile terminal 110 and the target network HRPD RNC 176. An HRPD RNC 176 normally sends overhead messages over the HRPD air interface 490; however, the HRPD tunnel protocol 485 in the HRPD RNC 176 provides an alternate path through sending the overhead messages over the X1 interface. This supports latency reduction (either in terms of time elapsed or lost packets) of handover in a heterogeneous network.

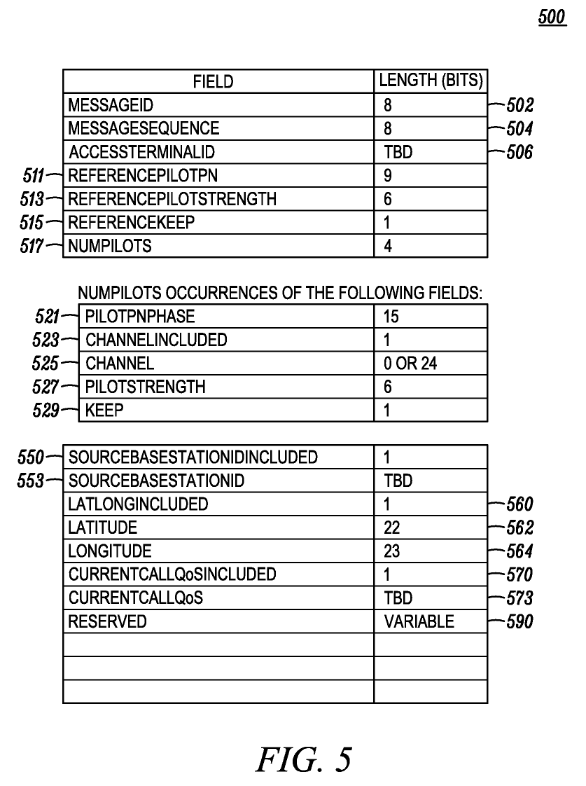

FIG. 5 is an example of a Target Overhead Update Request message 500. This request message 500 can be sent either unsecured (see unsecured request message 315 in FIG. 3) or secured (see secured request message 325 in FIG. 3). A mobile terminal 110, 210 sends the Target Overhead Update Request message 500 to a target SFF 178, 278 via the target tunnel control protocol 425, 455 or the HRPD tunnel protocol 415, 485 (see FIG. 4) to request an overhead message update that otherwise might be received over the target air interface 490. The message 500 can be sent as a UDP packet using a data connection over the source network 130, 230. Generally speaking, the message 500 contains source base station and/or mobile terminal location information that allows a target system to determine which target base stations may be able to connect to the mobile terminal 110 if the mobile terminal 110 was to switch to the target system air interface 430.

Standard messaging fields include a Message ID field 502, a Message Sequence field 504, and an Access Terminal ID field 506 for identifying the mobile terminal 110, 210.

Certain information may be included or excluded in the message 500 based on whether the information is considered sensitive and whether the message is being sent in a secured or unsecured format. A Source Base Station ID Included field 550 indicates whether a Source Base Station ID is included in the message 500. If a Source Base Station ID is included, it is sent in a separate field 553. A target network may use source base station information to determine which target base stations may be within coverage range of the mobile terminal 110.

A LatLong Included field 560 indicates whether a geographic location of the mobile terminal 110 is included in the message 500. If the geographic location is included, latitude is sent in a Latitude field 562 and Longitude is sent in a Longitude field 564. Optionally, altitude could be sent in an Altitude field (not shown). A target network can use geographic location information sent in this message 500 to determine which target base stations may be within coverage range of the mobile terminal 110.

A Current Call QoS Included field 570 indicates whether the QoS parameters of the current active call or calls (i.e., data sessions) on the source network is included in the message 500. If QoS parameters are included, it is stated in Current Call QoS field 573. A target network 170 can use the current call QoS information to determine whether it has sufficient resources to maintain the active call(s) after a handover.

Optional fields which may help the target network 170 locate the mobile terminal 110 include a Reference Pilot PN field 511 to state the mobile terminal's time reference (the reference pilot) relative to the zero offset pilot PN (in units of 64 PN chips), a Reference Pilot Strength field 513 to indicate reference pilot signal strength as measured by the mobile terminal, a Reference Keep field 515 to state whether the reference pilot drop timer has expired, and a Number of Pilots (NumPilots) field 517 to state the number of pilots that follow this field 517 in the message 500.

For each particular pilot as indicated in the NumPilots field 517, the message 500 may include a Pilot PN Phase field 521 to indicate the PN offset (in resolution of 1 chip) of a pilot in the Active Set or Candidate Set of the mobile terminal that is not the reference pilot, a Channel Included field 523 to state whether the channel for this particular pilot offset is the same as the current channel, an optional Channel field 525 for stating the channel record corresponding to this particular pilot if the Channel Included field 523 indicates that the channel for this particular pilot offset is not the same as the current channel, a Pilot Strength field 527 for indicating the signal strength of the particular pilot as measured by the mobile terminal, and a Keep field 529 to indicate if the pilot drop timer corresponding to this particular pilot has expired. Fields 511, 513, 515, 517 521, 523, 525, and 529 reflect current WiMAX and HRDP air interface 430 (see FIG. 4) values and may be implemented differently depending on the parameters of the source and target air interfaces.

The optional fields 511, 513, 515, 517, 521, 523, 525, 527, 529 are particularly useful for code division multiple access networks and may not be required depending on the air interface technology of the source network and the availability of the source base station ID 553. Note that source base station ID 553 is an example of any source base station parameter that can be used to locate the source base station and thus indirectly determine target base stations that are likely to be in the vicinity of the mobile terminal. Similarly, fields 562, 564 are dependent on whether the mobile terminal can determine its geographic coordinates. For OFDM-based networks, a similar set of parameters are available in the mobile terminal 110.

Finally, a Reserved field 590 may be used to extend the message 500 length to an integer number of octets.

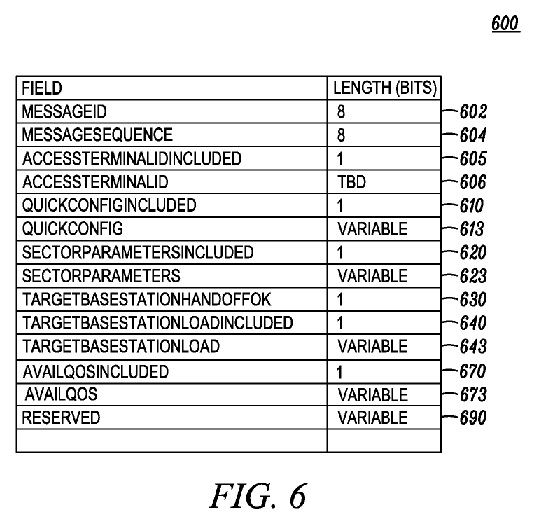

FIG. 6 is an example of a Target Overhead Update Response message 600. A target SFF 178, 278 sends this message 600 via an HRPD tunnel control protocol 425, 455 or the HRPD Tunnel Protocol 415, 485 (see FIG. 4) to the mobile terminal 110, 210. The message 600 contains information for one or more target base stations that are likely to be available at the mobile terminal's location. The message 600 may also include synchronization information to assist the mobile terminal 110 in tuning to the target air interface. Even imprecise timing information may be beneficial to assist the mobile terminal 110 in more quickly acquiring a target base station than the mobile terminal 110 would otherwise be able to do without the timing information. Optionally, the message also includes an indication of whether the target network 170, 270 or a specific target base station 176, 276 can accept a handoff, a current load of a target base station, and a set of QoS parameters currently available at a target base station.

Standard messaging fields include a Message ID field 602 and a Message Sequence field 604. If the message 600 is directed to a particular mobile terminal, an Access Terminal ID Included field 605 indicates so, and the mobile terminal ID is included in an Access Terminal ID field 606.

Certain information may be included or excluded in the message 600 based on whether the information is considered sensitive and whether the message is being sent in a secured or unsecured format. A Quick Config Included field 610 indicates whether quick configuration information for the target base station is included in this message 600. If quick configuration information is included, it is sent in field 613. Quick confirmation information can include PN noise codes for a code division multiple access target network. The mobile terminal 110, 210 can use this configuration information to speed up the process of tuning to the target air interface 430 (see FIG. 4).

A Sector Parameters Included field 620 indicates whether sector parameter information for the target base station 176, 276 is included in this message 600. If sector parameter information is included, it is sent in field 623. Sector parameter information can include color code information and sector identifier information. The mobile terminal 110, 210 can use this sector parameter information to speed up the process of tuning to the target air interface. Quick Config and Sector Parameters information is generally included in standard overhead messages, which is otherwise sent over-the-air from the target base station.

A Target Base Station Handoff OK field 630 indicates whether the target access network corresponding to the quick configuration and sector parameters in fields 613, 623 is willing to consider accepting a handoff request 353 (see FIG. 3) from the mobile terminal 110, 210. The target network may determine whether is willing to accept a handover request 353 based on information found at the target network—possibly augmented by information from Target Overhead Update Request message(s) 315, 325.

A Target Base Station Load Included field 640 indicates if the load of the target base station will be provided in the message 600. If the load will be provided, it is included in a Target Base Station Load field 643. In an embodiment, the load is sent as a percentage where 100% indicates that the target base station is at capacity and cannot accept a handoff and where 0% indicates that there are no calls in progress at the target base station. The mobile terminal 110 may use this load information to determine whether to handover to the target network and whether to select this particular target base station for handoff.

An Available QoS Included field 670 indicates if a set of QoS parameters currently available from the target base station is included in this message 600. If a set of QoS parameters available at the target base station is included, it is placed in Avail QoS field 673. The mobile terminal may use this QoS information to determine whether to hand over to the target network and which target base station to select for handoff.

Finally, a Reserved field 690 may be used to extend the message 600 length to an integer number of octets.

By receiving target overhead information regarding a target base station via an IP data tunnel through a source network rather than over-the-air to the target network, a mobile terminal can make a more educated decision regarding heterogeneous handover. This is particularly useful in MCHO methodologies within heterogeneous networks. Adding more information, such as whether a target base station will accept a handover from that mobile terminal, current base station loading information, and current QoS information, may further empower the mobile terminal in either an MCHO or an MAHO situation.

The inventive concepts disclosed herein are capable of many modifications. To the extent such modifications fall within the scope of the appended claims and their equivalents, they are intended to be covered by this patent application.

We claim:

1. A method, at a mobile terminal, for a hand-over comprising:
transmitting, to a target network, a target network overhead update request message containing location information of the mobile terminal;
receiving, from the target network, a target network overhead update response message containing overhead message information for the target network.

2. The method of claim 1, wherein the transmitting comprises:
sending the target network overhead update request message through a data tunnel from the mobile terminal to the target network.

3. The method of claim 2, wherein the data tunnel is from the mobile terminal through a source network to the target network.

4. The method of claim 1, wherein the receiving comprises:
acquiring the target network overhead update response message through a data tunnel.

5. The method of claim 1, wherein the target network overhead update request message includes a source base station identifier of the mobile terminal.

6. The method of claim 1, wherein the target network overhead update request message includes latitude and longitude information of the mobile terminal.

7. The method of claim 1, wherein the target network update request message further comprises:
a Quality of Service (QoS) level of a current connection of the mobile terminal.

8. The method of claim 1, wherein transmitting comprises:
sending the target network overhead update request message to a signal forwarding function (SFF) associated with the target network.

9. The method of claim 1, wherein transmitting comprises:
sending the target network overhead update request message to a base station associated with the target network.

10. A method, at a mobile terminal, for a mobile-controlled hand-over comprising:
receiving, from a target network, a target network update overhead response message containing overhead message information of the target network;
releasing a connection to a source network; and
establishing a connection to the target network.

11. The method of claim 10 further comprising:
transmitting, to the target network, a target network overhead update request message containing location information of the mobile terminal before the receiving.

12. The method of claim 10 further comprising:
transmitting a release message to the source network.

13. The method of claim 10, further comprising:
establishing a secure data tunnel for the receiving.

14. A method, at a target network, for a hand-over comprising:
receiving, from a mobile terminal, a target network overhead update request message containing location information of the mobile terminal; and
transmitting, to the mobile terminal, a target network overhead update response message containing overhead message information for the target network.

15. The method of claim 14, wherein the receiving comprises:
obtaining the target network overhead update request message through a data tunnel from the mobile terminal to the target network.

16. The method of claim 14, wherein the transmitting comprises:
sending the target network overhead update response message through a data tunnel.

17. The method of claim 16, wherein the data tunnel is from the target network through a source network to the mobile terminal.

18. The method of claim 14, wherein the target network overhead update response message comprises:
quick configuration information of the target network.

19. The method of claim 14, wherein the target network overhead update response message comprises:
sector parameter information of the target network.

20. The method of claim 14, wherein the target network overhead update response message further comprises:
an indicator of whether the target network will accept a hand-off from the mobile terminal.

21. The method of claim 14, wherein the target network overhead update response message further comprises:
a present load factor of a target base station.

22. The method of claim 21, wherein the present load factor is expressed in percentage of capacity currently being utilized at the target base station.

23. The method of claim 14, wherein the target network overhead update response message further comprises:
a Quality of Service (QoS) level available at a target base station.

24. The method of claim 14, wherein transmitting comprises:
sending the target network overhead update request message to a signal forwarding function (SFF) connected to the mobile terminal via an X1 protocol.
